(19) United States
(12) Patent Application Publication
(10) Pub. No.: US 2014/0202964 A1
(43) Pub. Date: Jul. 24, 2014

(54) ANTIMICROBIAL POLYCATIONIC SAND FILTER FOR WATER DISINFECTION

(71) Applicant: Northeastern University, Boston, MA (US)

(72) Inventors: April Z. GU, Newton, MA (US); Alexander M. KLIBANOV, Boston, MA (US); Annalisa ONNIS-HAYDEN, Milton, MA (US); Bryan B. HSU, Thousand Oaks, CA (US); Kim LEWIS, Newton, MA (US)

(73) Assignee: Northeastern University, Boston, MA (US)

(21) Appl. No.: 13/891,742

(22) Filed: May 10, 2013

Related U.S. Application Data
(60) Provisional application No. 61/645,358, filed on May 10, 2012.

(51) Int. Cl. C02F 1/50

(52) U.S. Cl. CPC C02F 1/50
USPC 210/764; 210/287; 210/504

(57) ABSTRACT

A composition comprised of sand and a hydrophobic polycationic polymer covalently bonded to the sand is provided. Exemplary polycationic polymer are N,N-hexyl, methyl-PEI or N,N-dodecyl, methyl-PEI. This antimicrobial polycationic sand filter uses the antimicrobial properties of hydrophobic polycations (N-hexylated polyethylenimine). The sand filter inactivates microorganisms, as water is run through the sand. Preliminary sand washing methods can be used regenerate the inactivation efficacy. Unlike traditional water disinfectants, the polycationic sand filter does not create harmful disinfection byproducts and does not require large chemical and energy consumption.

### CROSS-REFERENCE TO RELATED APPLICATIONS

This application claims the benefit under 35 U.S.C. §119(e) to U.S. Provisional Patent Application No. 61/645,358 entitled An Antimicrobial Polycationic Sand Filter for Water Disinfection, filed on May 10, 2012, the content of which is incorporated herein by reference in its entirety.

### SPONSORSHIP INFORMATION

This invention was made with government support under DAAD-19-02-D-002 awarded by the U.S. Army through the Institute for Soldier Nanotechnologies at MIT. The government has certain rights in this invention.

### BACKGROUND

1. Field of the Invention

The present invention relates to a filtration system for water disinfection and more specifically to an antimicrobial polycationic sand filter for water disinfection.

2. Description of Related Art

Disinfection by chlorination as the last step of drinking water and wastewater treatments has played a critical role in protecting the U.S. water supply from waterborne infectious diseases. However, harmful disinfection byproducts (DBPs) produced during the chlorination process, such as carcinogenic trichloromethanes and chloroacetic acids, have raised concerns and motivated exploration of other disinfection agents (See Cantwell, R. E., Hofmann, R. & Templeton, M. R. 2008 Interactions between humic matter and bacteria when disinfecting water with UV light. Journal of Applied Microbiology 105 (1), 25-35.) Such alternative disinfectants have included chloramines, ozone, UV, peracetic acid, bromine, and advanced oxidants (See Freese, S. D. & Nozaic, D. J. 2004 Chlorine: Is it really so bad and what are the alternatives? Water SA 30, 566-572.) Among these, the first three have been studied most extensively and proven effective for large-scale treatment.

Although these alternative disinfectants lower regulated chlorinated DBP levels, they can give rise to other toxic DBPs (Richardson, S. D. 2003 Disinfection by-products and other emerging contaminants in drinking water. TrAC-Trends in Analytical Chemistry 22 (10), 666-684.) Ozonation, for example, can lead to the formation of aldehydes, ketones and carboxylic acids, many of which have been found to be mutagenic or carcinogenic (See Freese & Nozaic 2004). Although UV does not produce such residuals, it is energy-intensive and the effectiveness of UV disinfection varies with water quality (Moreno, B., Goni, F., Fernandez, O., Martinez, J. A. & Astigarraga, M. 1997 The disinfection of wastewater by ultraviolet light. Water Science and Technology 35 (11-12), 233-235). Another troubling aspect is disinfection resistance phenomena. Different levels of resistance to both chlorination and UV have been observed with bacteria, viruses, and protozoa (Hijnen, W. A. M., Beerendonk, E. F. & Medema, G. J. 2006 Inactivation credit of UV radiation for viruses, bacteria and protozoan (oo)cysts in water: a review. Water Research 40 (1), 3-22; LeChevallier, M. W., Cawthon, C. D. & Lee, R. G. 1988 Factors promoting survival of bacteria in chlorinated water supplies. Applied Environmental Microbiology 54 (3), 649-654). These issues motivate the exploration of novel effective disinfection methods that form no harmful DBPs and can be more effective towards resistance phenomena.

Recently, a sterile-surface material—“antimicrobial polymer”—has been developed and validated based on hydrophobic polycations, such as N-alkylated polyethylenimine (N-alkyl-PEI), either covalently attached or deposited (“painted”) onto surfaces (Klibanov, A. M. 2007 Permanently microbicidal materials coatings. Journal of Materials Chemistry 17 (24), 2479-2482; Lewis, K. & Klibanov, A. M. 2005 Surpassing nature: rational design of sterile-surface materials. Trends in Biotechnology 23 (7), 343-348). The resultant derivatized surfaces kill on contact both airborne and waterborne pathogenic bacteria (gram-positive and gram-negative), as well as fungi and influenza viruses (Klibanov 2007). The hypothesized antimicrobial mechanism involves the physical rupture of cellular membranes or viral envelopes by long-chained, moderately hydrophobic immobilized polycations (See Milovic, N. M., Wang, J., Lewis, K. & Klibanov, A. M. 2005 Immobilized N-alkylated polyethylenimine avidly kills bacteria by rupturing cell membranes with no resistance developed. Biotechnology and Bioengineering 90 (6), 715-722).

Polymeric disinfectants are ideal for applications in water treatment because they can inactivate, kill, or remove target microorganisms by mere contact without releasing any reactive agents to the bulk phase to be disinfected (See Kenawy, E. R., Worley, S. D. & Broughton, R. 2007 The chemistry and applications of antimicrobial polymers: a state-of-the-art review. Biomacromolecules 8 (5), 1359-1384); however, only a limited number of studies have explored this field of research. A water-insoluble matrix based on iodinated poly(methyl methacrylate-co-N-vinyl-2-pyrrolidone) has been synthesized for use in a portable water treatment device. (See Tyag, M. & Singh, H. 2000 Iodinated P (MMA-NVP): an efficient matrix for disinfection of water. Journal of Applied Polymer Science 76, 1109-1116.) In a recent study, N-halamine polymers in the form of highly cross-linked porous beads have been explored for use in drinking water disinfection (See Chen, Y. J., Worley, S. D., Kim, J., Wei, C. I., Chen, T. Y., Santiago, J. I., Williams, J. F. & Sun, G. 2003 Biocidal poly(styrenehydantoin) beads for disinfection of water. Industrial & Engineering Chemistry Research 42 (2), 280-284). In this mentioned study, functionalization of methylated polystyrene by halogenated hydantoin and imidazolidinone derivatives was used in packed glass columns and the column filter biocidal efficacy tests showed effective reduction of S. aureus and E. coli. In both of these studies, however, the hydrophilic water-insoluble copolymer matrix or beads were used to immobilize a suitable antimicrobial agent, which can slowly release into the water, and therefore will need to be recharged, or discarded after use. In addition, the use of brominated beads is limited to disinfection of water systems because of the toxicity of emitted free bromine to the water.

### SUMMARY OF THE INVENTION

In an aspect of the present invention, a method of disinfecting water is provided. The method includes providing sand, where said sand is covalently bonded to a polycationic polymer, and disinfecting water by filtering said water through said sand.

In another aspect of the present invention, a water purification system is provided. The system includes an elongate housing having a first end and a second end, said first end including surfaces defining a water inlet for admitting water into the housing, and said second end including surfaces defining a water outlet. The system also includes biological purifiers disposed within the housing for killing biological organisms in the water. The biological purifiers include sand covalently bonded to a polycationic polymer.

In another aspect of the present invention, a composition including sand and a hydrophobic polycationic polymer covalently bonded to the sand is provided.

### BRIEF DESCRIPTION OF THE DRAWINGS

FIG. 1A illustrates a structure of linear Polyethylenimine. FIG. 1B illustrates a structure of branched Polyethylenimine.

FIG. 2 illustrates a structure of N,N-hexyl, methyl-PEI.

FIG. 3 illustrates an antimicrobial polymeric sand filter according to embodiments of the present invention.

FIG. 4 illustrates inactivation of E. coli by N,N-hexyl, methyl-PEI immobilized on the surface of sand filtration in PBS buffer according to embodiments of the present invention.

FIG. 5 illustrates log reduction of E. coli in raw secondary effluent and in bacterial-spiked autoclaved secondary effluent by N,N-hexyl, methyl-PEI covalently immobilized on the surface of sand according to embodiments of the present invention.

FIG. 6 illustrates observed correlation of log reduction of E. coli concentration with empty bed contact time (EBCT) according to embodiments of the present invention.

### DETAILED DESCRIPTION OF THE INVENTION

In an aspect of the present invention, a method of disinfecting water is provided. The method includes providing sand, where said sand is covalently bonded to a polycationic polymer, and disinfecting water by filtering said water through said sand.

In an embodiment, the sand can be silica sand.

In another embodiment, the polycationic polymer can be N-alkylated polyethylenimine (PEI). Various embodiments use different types of N-alkylated polyethylenimine. Polyethylenimine can be branched. The N-alkylation can be achieved by disubstitution of R1 and R2 at the N position, and wherein each R1 and R2 is independently selected from C1-C24. Each R1 and R2 can be independently selected from C1-C12. Alternatively, each R1 and R2 can be independently selected from C1-C16. Each R1 and R2 can be independently selected from methyl, hexyl, and dodecyl. The polycationic polymer can be N,N-hexyl, methyl-PEI or N,N-dodecyl, methyl-PEI.

In another aspect of the present invention, a water purification system is provided. The system includes an elongate housing having a first end and a second end, said first end including surfaces defining a water inlet for admitting water into the housing, and said second end including surfaces defining a water outlet. The system also includes biological purifiers disposed within the housing for killing biological organisms in the water. The biological purifiers include sand covalently bonded to a polycationic polymer.

In an embodiment, the water purification system can also include solids purifiers disposed within the housing for removing solid contaminants from the water.

In another embodiment, the sand can be silica sand.

In yet another embodiment, the polycationic polymer of the system can be N-alkylated polyethylenimine (PEI). Various embodiments use different types of N-alkylated polyethylenimine. Polyethylenimine can be branched. The N-alkylation can be achieved by disubstitution of R1 and R2 at the N position, and wherein each R1 and R2 is independently selected from C1-C24. Each R₁ and R₂ can be independently selected from C₁-C₁₂. Alternatively, each R₁ and R₂ can be independently selected from C₁-C₁₆. Each R₁ and R₂ can be independently selected from methyl, hexyl, and dodecyl. The polycationic polymer can be N,N-hexyl, methyl-PEI or N,N-dodecyl, methyl-PEI.

In another aspect of the present invention, a composition including sand and a hydrophobic polycationic polymer covalently bonded to the sand is provided.

In another embodiment, the sand can be silica sand.

In yet another embodiment, the hydrophobic polycationic polymer of the composition can be N-alkylated polyethylenimine (PEI). Various embodiments use different types of N-alkylated polyethylenimine. Polyethylenimine can be branched. The N-alkylation can be achieved by disubstitution of R1 and R2 at the N position, and wherein each R1 and R2 is independently selected from C1-C24. Each R1 and R2 can be independently selected from C1-C12. Alternatively, each R1 and R2 can be independently selected from C1-C16. Each R1 and R2 can be independently selected from methyl, hexyl, and dodecyl. The polycationic polymer can be N,N-hexyl, methyl-PEI or N,N-dodecyl, methyl-PEI.

An antimicrobial polycationic sand filter is provided. The antimicrobial polycationic sand filter can be made by covalently bonding polycationic polymer onto sand surface, and it can be used as a polymeric disinfectant for water filtration and disinfection. The polycationic polymer may be alkylated. Some exemplary polycationic polymers include N-hexyl-PVP, N,N-hexyl, methyl-PEI, N,N-dodecyl, methyl-PEI, and N,N-octadecyl,Methyl-PEI. Several advantages of this disinfection method for advanced wastewater treatment or for portable water treatment devices exist. For example, this disinfectant technique eliminates DBPs since it involves no chemicals that react with organic precursors in water and requires neither added chemicals (as in chlorination) nor extensive energy (as with UV disinfection). This allows it to be used for field application, military uses etc., where chemical and energy supply is limited. Moreover, it can be combined into a single process with filtration, which is commonly used in water treatment as a final step to remove suspended particles and colloids before disinfection. This leads to unit process foot-print reduction and cost-saving. Furthermore, the immobilized polycations do not seem to be subject to the existing mechanisms of microbial resistance (Milovic et al. 2005) and thus may be effective against microorganisms that have developed resistance to chlorine upon repeated long-term exposure. Finally, the antimicrobial property of these polycations can be easily regenerated by a simple washing step. (Lin, J., Qiu, S. Y., Lewis, K & Klibanov, A. M. 2003 Mechanism of bactericidal and fungicidal activities of textiles covalently modified with alkylated polyethylenimine. Biotechnology and Bioengineering 83 (2), 168-172.)

The present invention describes a polycationic polymer (e.g., polymers include N-hexyl-PVP, N,N-hexyl, methyl-PEI, N,N-dodecyl, methyl-PEI, and N,N-octadecyl,Methyl-PEI) coated filtration process and the filtration media can be commercial sand or potentially other media. More descriptions on polycationic polymers are in Klibanov, A. M. 2007 Permanently microbicidal materials coatings. Journal of Materials Chemistry 17, 3679-2482 and Larson A. M. 2010 Hydrophobic Polycationic coatings disinfect poliovirus and rotavirus solutions. Biotechnology and Bioengineering 10/2010: 108(3): 720-3, the contents of which are incorporated by reference herein in its entirety. The polycationic sand filter is examined for its robustness of polymer immobilization. The inactivation of indicator microorganisms in a lab-scale filter filled with polymer-coated sand is also provided. Different reactor operating conditions and water samples were evaluated to identify the parameters that affect the disinfection efficiency, including empty bed contact time (EBCT), characteristics of water matrix, and backwash/cleaning procedures.

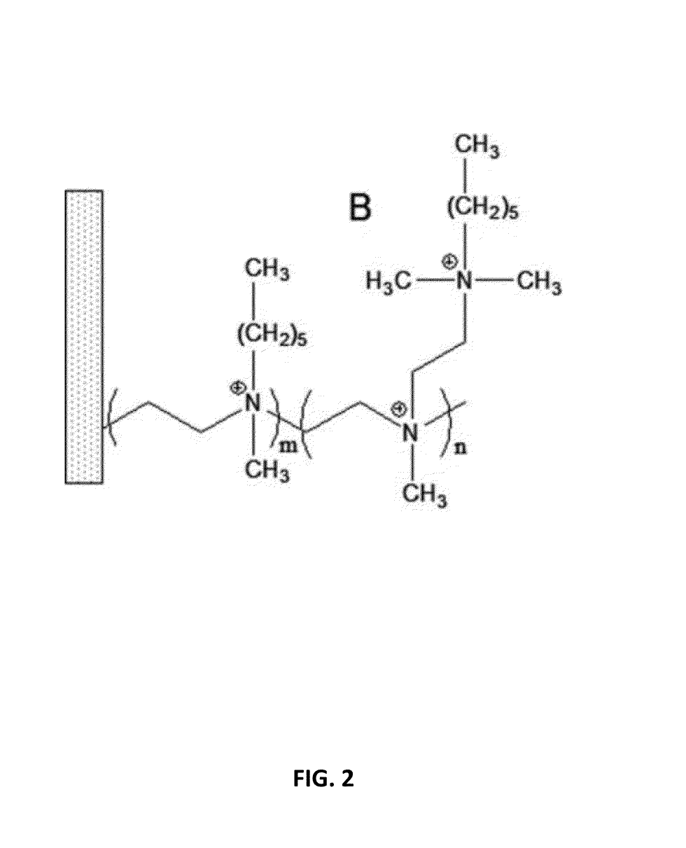

The testing and illustrations below use N,N-hexyl, methyl-PEI as shown in FIG. 2, but the invention is not limited to the use of N,N-hexyl, methyl-PEI. Other polycationic polymers, which may be alkylated, can be used.

### Materials and Methods

### Materials

Silica sand can be used for the base material where polycations are covalently attached. Silica sand can be obtained from commercial sources such as Ricci Bros. Sand Co. Inc. (Port Norris, N.J.). In one embodiment, Silica sand with nominal diameter of 0.5 mm is used. Branched PEI (average Mw of 750 kDa, 50 wt % in water), organic solvents and chemical reagents can be purchased from chemical suppliers, for example, Sigma-Aldrich Chemical Co. (Saint Louis, Mo.). The chemicals can be used without further purification or with purification. For example, tert-amyl alcohol can be dried over 3 A molecular sieves. For testing, E. coli (K12, MG1655) was kindly provided by Dr. Kim Lewis in the Biology Department at Northeastern University (Massachusetts, U.S.). Environmental wastewater secondary effluent was obtained from the Deer Island wastewater treatment plant, Winthrop, Massachusetts.

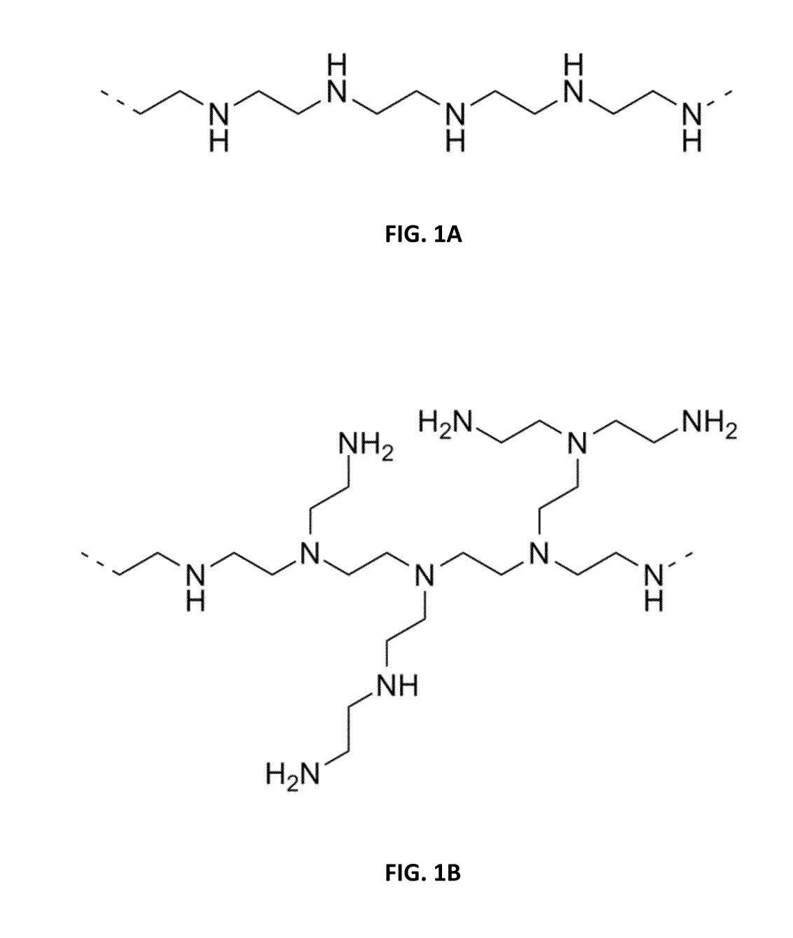

Polyethyleneimine (PEI) has a repeating unit composed of the amine group and two carbon aliphatic CH2CH2 spacer. PEI can be either linear as shown in FIG. 1A or branched as shown in FIG. 1B. Linear PEIs contain all secondary amines and are solid at room temperature, whereas branched PEIs contain primary, secondary, and tertiary amino groups and are liquids at room temperature. Depending on the reaction conditions, different degree of branching can be achieved.

### Polycation Immobilization to Sand

An exemplary procedure to immobilize polycations to sand is presented below. It is adopted from previous publications with modifications. (See Lin, J., Qiu, S. Y., Lewis, K & Klibanov, A. M. 2002a Bactericidal properties of flat surfaces and nanoparticles derivatized with alkylated polyethylenimines. Biotechnology Progress 18 (5), 1082-1086 and Lin, J., Tiller, J. C., Lee, S. B., Lewis, K. & Klibanov, A. M. 2002b Insights into bactericidal action of surface-attached poly(vinyl-N-hexylpyridinium) chains. Biotechnology Letters 24 (10), 801-805).

The following procedure is a non-limiting embodiment of the present invention, and the procedure can vary. For example, the amount chemical compositions, the exact chemicals, the time it takes for each step, and the degree at which the sand is dried can vary.

The polycation process includes animation, titration of amino groups, bromoacylation, covalent attachment of branched PEI, and methylation.

Exemplary animation steps are described. In step 1, 250 g of sand with 0.5 mm diameter is prepared by thoroughly washing in distilled water, sonicating in isopropanol for 5 min, and drying in oven at 80° C. overnight. In step 2, the cleaned sand is then suspended in 200 mL of 20% 3-aminopropyltriethoxysilane solution composed of 40 ml 3-APTES and 160 ml dry toluene. In step 3, the solution with sand is stirred at room temperature for 3 hours. The sand is subsequently washed in toluene in step 4 and washed with methanol in step 5. In step 6, the sand is dried at 80° C.

Exemplary steps of titrating amino groups using 1 g of treated sand and 1 g of untreated sand is provided. In step 1, the sand is washed with dichloromethane. In step 2, both treated and untreated sand is incubated in 2 ml of 50% triethylamine solution (i.e., 1 ml triethylamine and 1 ml dichloromethane) for 10 minutes. In step 3, the sand is washed thoroughly with dichloromethane. In step 4, the sand is incubated in 2 ml of 0.1M picric acid (0.7 g Picric Acid in 2 ml dichloromethane) for 5 minutes. In step 5, the sand is wash thoroughly with dichloromethane. In step 6, the sand is incubated with 2 ml N,N-diisopropylethylamine (DIPEA). In step 7, the sand is washed with 2 ml methanol, and washings and DIPEA are collected for disposal. In step 8, steps 6 and 7 are repeated. In step 9, the absolvent at 358 nm are examined. In step 10, if absolvent is less than 0.1, a rotary evaporator is used on the sand for efficient and gentle removal of solvent (i.e., methanol).

Exemplary bromoacylation steps are disclosed. In step 1, sand is incubated in 200 ml 5% triethylamine solution, composed of 10 ml triethylamine and 190 ml chloroform. In step 2, the sand is washed thoroughly. In step 3, the sand is incubated in solution of 10 mL of 4-bromobutyryl chloride and 190 ml chloroform. In step 4, the solution containing the sand is stirred at room temperature for 14 hours. The sand is consecutively washed with anhydrous chloroform in step 5, anhydrous methanol in step 6, and tert-amyl (t-amyl) alcohol in step 7.

Exemplary steps for covalent attachment of branched PEI is provided. In step 1, 40 g of branched PIE and 1.0 g of potassium hydroxide is dissolved in 200 ml tert-amyl alcohol. In step 2, sand is incubated in the solution at 90° C. for 18 hours. In step 3, the sand is washed with t-amyl alcohol and dried.

Exemplary steps for alkylation of sand-immobilized PEI is provided. In step 1, sand is incubated in 200 ml solution of 20 ml 1-bromohexane, 1.0 g potassium hydroxide, and 180 ml t-amyl alcohol. In step 2, the solution with incubated sand is heated and stirred for 24 hours at 90° C. In step 3, the sand is washed with t-amyl alcohol.

Exemplary steps for methylation are provided. In step 1, sand is incubated in 200 ml solution, composed of 40 ml iodomethane and 160 ml t-amyl alcohol. In step 2, the solution is heated and stirred at 60° C. in a sealed bottle for 24 h. In step 3, the sand is washed extensively with t-amyl alcohol, and in step 4, the sand is washed with methanol and dried at 80° C. in an oven overnight.

The final yield of N,N-hexyl,methyl-PEI treated sand is obtained and the protocol is repeated several times to obtain a desired amount.

### Titration of Quaternary Ammonium Groups

To determine the amount of polymer covalently immobilized to sand, after covalent immobilization of N,N-hexyl, methyl-PEI to the sand's surface, titration of the quaternary ammonium groups can be performed using a fluorescein assay. An exemplary procedure is adopted from Tiller et al. (See Tiller, J. C., Liao, C. J., Lewis, K & Klibanov, A. M. 2001. Designing surfaces that kill bacteria on contact. Proceedings of the National Academy of Sciences of the United States of America 98 (11), 5981-5985) 1.0 g of sand is shaken at room temperature with 5 mL of 1% fluorescein aqueous solution (Na salt) for 5 min. The sand is then thoroughly washed with 100 mL distilled water and then sonicated for 15 min in 4 mL of a 0.25% cetyltrimethylammonium chloride aqueous solution to displace the polycation-bound fluorescein into solution. This detergent solution is then decanted from the sand and 0.444 mL of 0.1 M phosphate buffer, pH 8.0, is added. After brief centrifugation to remove any fine sand particles, if present, the absorbance at 501 nm is measured. Using the previously determined molar extinction coefficient, 7.7×10⁴ M⁻¹·cm⁻¹ (Tiller et al. 2001), the density of quaternary ammonium groups per gram of polycation-treated sand is determined to be 95±32 nmol/g. In comparison, untreated sand gives a background density of 17±1 nmol/g, which may be attributed to the heterogeneous elemental composition of the sand.

### Preliminary Evaluation of Antibacterial Efficacy of the Polycation-Coated Sand

In addition to the titration of quaternary ammonium groups for evaluating the effectiveness of polymer coating onto sand surface, a pre-evaluation of the sand antibacterial efficacy can be determined by an inactivation assay, in which 5.0 g of sand was shaken at 200 rpm with 10 mL of 10⁷ bacterial cells/100 mL for 2 h at 37° C. Evaluation of the aliquots (100 μL) of the incubated bacterial suspensions diluted 10fold in phosphate-buffered saline (PBS) are plated onto YDB-agar plates, in triplicate, and then incubated at 37° C., overnight. Comparison of the number of colony forming units (CFU) between bacterial suspensions incubated with untreated sand (331±32 CFU) and polycation-treated sand (0±0 CFU) demonstrates the latter has 100% bactericidal activity against waterborne E. Coli under these assay conditions.

### Sand Disinfection Filter Configuration

A sand filtration water disinfection technology that relies on antimicrobial properties of the immobilized hydrophobic polycation, e.g., N,N-hexyl, methyl-PEI and N,N-dodecyl,methyl-PEI. The polycation is covalently bonded to the surface of sand. The disinfection filter can have various process configurations (e.g. dual sand media, increased column depth).

The antimicrobial polycationic sand can be added to water during the water treatment process. Alternatively, the antimicrobial polycationic sand can be contained in a container allowing water flow in and out of the container. For example, some or all surfaces of the container can be in a mesh form that allows liquid flow but prevents the antimicrobial polycationic sand from leaving the container.

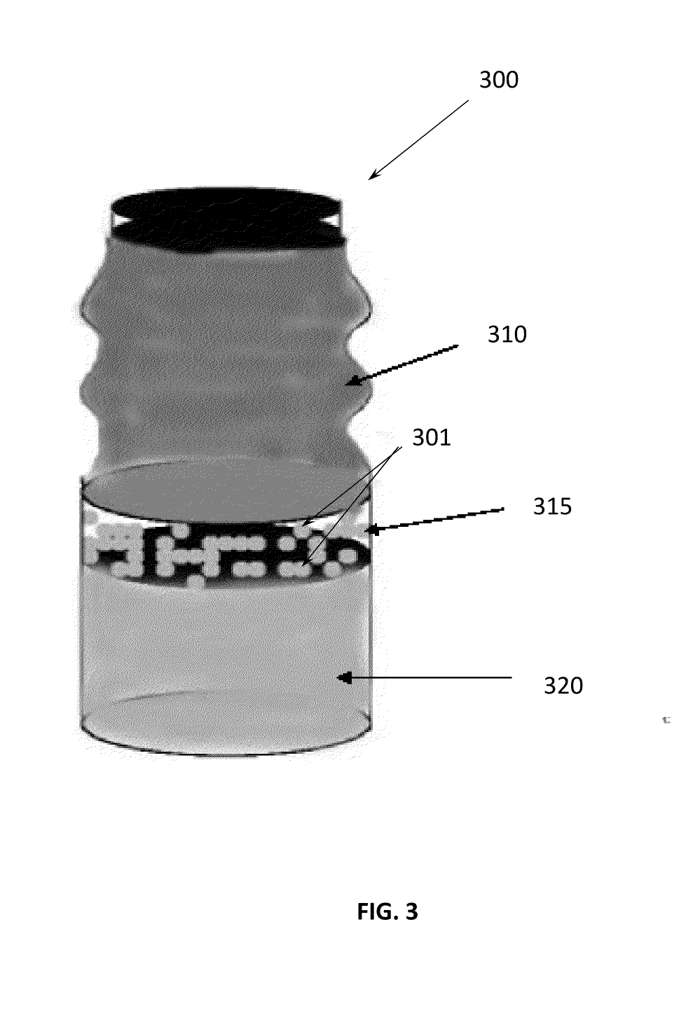

In some embodiments, the container can have an inlet and an outlet. FIG. 3 shows an exemplary embodiment of the antimicrobial polycationic sand disinfection filter 300. The sand disinfection filter 300 includes water inlet 310, disinfecting region 315, and water outlet 320. Water enters through water inlet 310 to disinfecting region 315, where water is disinfected by polycationic sand 301. Then, disinfected water exits the sand disinfection filter 300 through water outlet 320.

This disinfection filter can be attached at the water source entry of the house or at a faucet. Also, the disinfection filter can be attached anywhere in the middle of a water pipe. The sand disinfection filter can be used as a stand-alone unit or in conjunction with other filtering units, such as PUR®, Brita®, or refrigerator built-in filters.

This polycationic sand disinfection technique can provide an effective disinfection technology without the need for chemical treatment, electricity, or as an additional line of defense. Some of the areas where this technique can be used include all water treatment that involves granular media filtration including, but not limited to, municipal water treatment plants for surface and groundwater sources; point of use water disinfection units, tertiary wastewater treatment for reuse, stormwater treatment and swimming pools. In addition, this polycationic sand disinfection filter can be useful to disinfect water in adverse conditions (e.g. rural areas in developing countries, or for military personnel in war zones).

The polycationic sand can be contained a portable device that can provide drinkable water treatment. The portable device can be especially useful for campers, hikers, and soldiers. This portable device with polycationic sand.

Exemplary applications of the polycationic sand filter are provided.

Waters that are used for drinking, manufacturing and farming must meet certain contamination standards set by the U.S. Environmental Protection Agency (EPA) in the United States. For wastewater to be reused or return to nature, pollutants such as organic wastes, suspended solids, bacteria, nitrates, and phosphates must be removed. Primary wastewater treatment involves sedimentation to remove suspended solid in raw wastewater. Secondary treatment extracts organic matter remaining after the primary treatment. Tertiary treatment is to remove nitrogen, bacteria and pathogens to meet the EPA standard. Polycationic sand filter can be customized for large scale to provide the tertiary wastewater treatment.

Storm water treatments typically include storage in ponds where evaporation and seepage take place, and diversion to natural or artificial wetlands, where pollutants are removed by vegetation and sedimentation, and water is returned to atmosphere by evaporation. However, due to the large volume of water generated by storms, it is not practical to divert water to the natural treatments or the industrial wastewater treatment plants. Devices can be inserted into the storm water system to remove suspended solids and pollution. The polycationic sand can be used in conjunction with the devices for disinfection. Depending upon the regulations, similar to the wastewater treatment, the polycationic sand for storm water treatment can be a very cost-effective solution.

Whether it is private, commercial indoor or outdoor swimming pools, they must be sanitized to prevent growth and spread of bacteria, algae, viruses and insect larvae that can cause disease. This is done by filtering and chemical disinfectants. Typical swimming pools use chlorine for disinfection that can be hazardous to the environment and is carcinogenic. The polycationic sand can be an efficient disinfectant for swimming pools because of environmental and cost reasons. The polycationic sand is “green”—that is, environmentally safe and consumer safe. It also does not require frequent replacement. The polycationic sand can be integrated with the swimming pool filtering system to provide disinfection with very low operational costs.

### Disinfection Efficiency of the Polycation-Coated Sand Filter—Lab-Scale Testing

### Culture Growth

E. Coli is grown in Luria-Bertani (LB) medium overnight at 37° C. to reach the stationary phase (˜3.5×10¹⁰ CFU/100 mL). A known amount of the overnight culture is then spiked into either PBS (in 1 L of distilled water: 8.00 g of NaCl, 0.20 g of KCl, 1.44 g of Na₂HPO₄, 0.24 g of KH₂PO₄, with pH adjustment to 7.4) or other real environmental water samples to prepare influents for our disinfection filters (E. Coli concentrations of 10⁵ to 10⁹ CFU/100 mL).

### Column Testing Set-Up

Two bench-scale sand filtration systems are set up in parallel, with one containing N,N-hexyl,methyl-PEI-sand and the other the same amount of clean sand as a control. Each filtration unit includes a glass column (4.5 cm ID, 20 cm long) wet-packed by allowing sand grains to settle in deionized water upon agitation. The resultant column packing porosity is determined gravimetrically to be 0.40, and the total height of the packing in the column is approximately 10 cm (roughly 250 g of sand).

A typical experiment involves running 250 mL of the influent containing the bacteria through the column with a 1 cm water head maintained on top of the sand to allow even distribution of the influent. Effluent samples are collected after approximately two pore volumes (one pore volume is about 48 mL) of bacteria suspension are passed through the filter; about 150 mL of cumulated effluent is collected and used for further testing. Empty bed contact time ranging from 12 to 27 min is tested by adjusting the influent flow rates (7.8-14 mL/min).

### Inactivation Efficacy Assessment

The influent and effluent samples from both the test and control filters are collected and quantified for E. Coli contents using a membrane filter-plate counting method using LB agar medium or Coliscan medium (Microbiology Laboratories, Goshen, Indiana). Different sample dilutions are applied to ensure appropriate CFU after 18 to 24 h of incubation at 37° C.; averages of triplicate samples are calculated for each sample. The bactericidal efficiencies and log reductions can then be determined.

Although only one indicator organism (E coli) has been tested with the filter, it is expected that it should be effective towards other pathogens and indicators based on the inactivation mechanisms and preliminary tests on polymer-coated surfaces.

### Sand Washing

In some embodiments, the sand can be washed after each use or a number of use to improve its efficacy. The efficacy of sand washing on inactivation can be tested using the exemplary methods below.

Before and after each test, 400 mL of sterile PBS is run through the filter to clean it and remove any residual bacteria. When a decrease in efficiency is observed, a more rigorous cleaning procedure is performed prior to further testing using 70% (v/v) ethanol (EtOH), followed by distilled water. The ethanol washing procedure can be performed by leaving the ethanol in static contact with the sand for 10 min, then allowing it to flow though the sand with similar rates as in the tests, followed by 10 pore volumes of deionized water (about 400 mL).

### Test Results

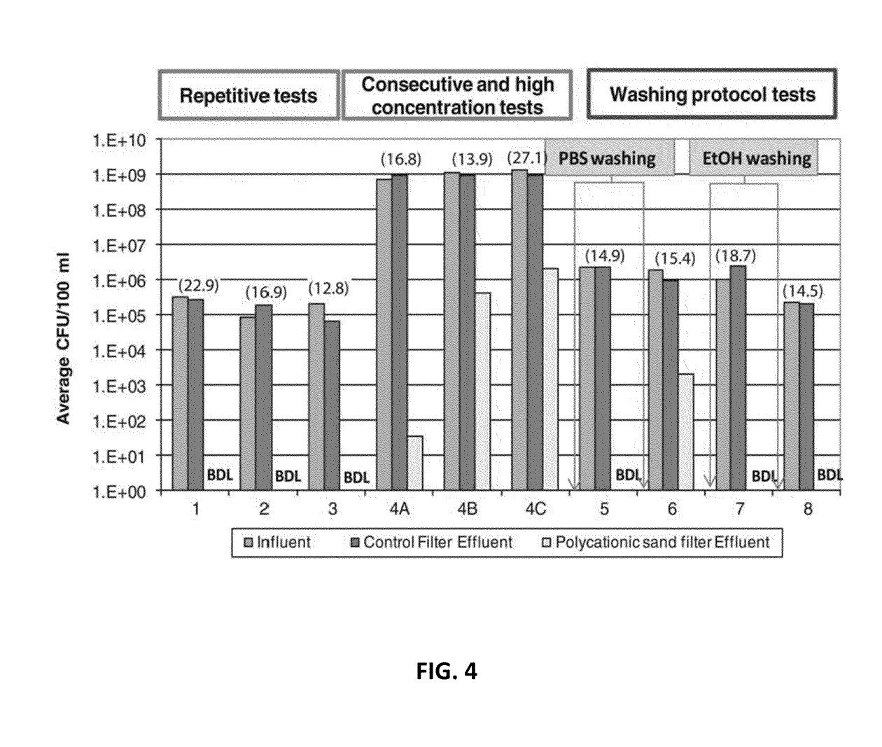

The efficacy of N,N-hexyl,methyl-PEI-immobilized sand in batch filtration mode is first evaluated herein using PBS spiked with E. Coli. The results depicted in FIG. 4 indicate a greater than 5-log reduction and essentially 100% removal of E. Coli for the first three test runs conducted on different dates with initial bacterial concentration of 10⁵ CFU/100 mL. When the influent E. Coli concentration is increased to 10⁹ CFU/100 mL, a bacterial count reduction of over 7 logs is achieved in the initial test (FIG. 4, Test 4A); however, subsequent tests of the filter conducted on the same day shows decreased reduction (FIG. 4, Tests 4B and 4C). To address this lowered performance, we perform a longer PBS cleaning of the sand by passing PBS through the filter for 15-20 min and then conducting the test with initial E. Coli concentration at 10⁶ CFU/100 mL. This treatment essentially recovers the original high disinfection efficiency—100% bacterial removal and an over 6-log reduction.

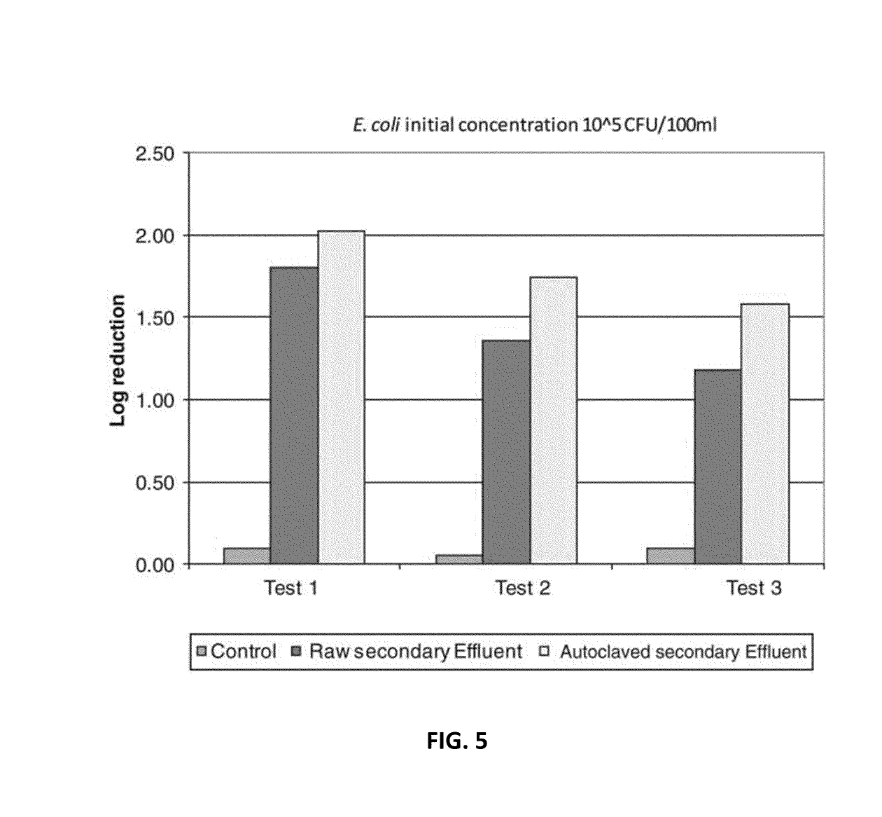

To evaluate the impact of wastewater matrix on the antimicrobial performance of N,N-hexyl,methyl-PEI-sand, we conduct similar tests with both raw secondary effluent from a local wastewater treatment plant (Deer Island) and autoclaved effluent spiked with E. Coli. FIG. 5 shows that, with raw wastewater effluent samples, only a limited reduction (1.2 to 2 logs) of E. Coli is achieved at the initial concentration of 10⁵ CFU/100 mL. Thus, the disinfection efficiency with real wastewater is much lower than that with a PBS model system at the same initial concentration (2.9-5.5 log kill, see FIG. 4). These results suggest that the wastewater matrix, likely organic particulate or colloidal particulate matter, reduces the contact efficiency between the immobilized polycation and the suspended bacteria. However, it should be noted that we employed the worst-case scenario with the secondary wastewater effluent here. The proposed disinfection method may be used for water treatment or for advanced tertiary wastewater treatment for water reuse, and not for wastewater secondary effluent as above. Moreover, for practical applications, a dual-sand filter in series can be implemented with the first-stage filter removing the particulate/colloids, followed by a polymer-coated sand filter for disinfection. The upper stage of the filter containing untreated sand, with the aid of coagulants, can act as a regular filter for removing colloidal and some organic matters that may potentially compete with microorganisms for active sites on the sand surface. More testing can be performed to determine the optimal washing/backwashing duration and operating conditions for this dual filter system.

As shown in FIG. 4, three consecutive tests conducted on the same day (Tests 4A, 4B, and 4C) with the same initial E. Coli concentration shows decreased antibacterial performance over time, likely due to bacterial debris contaminating the surface and shielding suspended live bacteria from contact with the coated surface. After thorough cleaning with PBS, the original microbicidal efficacy is essentially recovered. However, further continuous tests of the filter result in reduced performance again. We then explore the cleaning using ethanol, and the antibacterial efficiency is re-established, as seen in the following tests (tests 7 and 8 in FIG. 4).

The present disclosure provides two exemplary cleaning methods, including PBS and ethanol washing. However, there can be other methods for cleaning the polymer-treated sand. PBS is commonly used in biological applications as a multipurpose sterile and benign medium because of its physiological pH and osmotic balance with the cell cytoplasm. It was shown in the previous study that transiently attached bacterial cells on the slides coated by the same polymer could be easily washed off using PBS (Milovic et al. 2005). On the other hand, ethanol can provides efficient washing method because the hypothesized mechanism of the hydrophobic polycations, bactericidal activity involves disruption of the bacterial membrane by electrostatic and hydrophobic interaction with the polymer coating. Ethanol at 70% (v/v) is known to be very effective in dehydrating proteins, and therefore this property can be used to render the attached dead bacteria insoluble and remove them simply by running distilled water after the treatment with ethanol. Displacement of the biological debris in solution can be washed with a common hand-soap solution. The common hand-soap can refresh bactericidal activity of the polymer (Lin et al. 2003). It was also observed that after the filter was left idle for a certain period (12-36 hours, for example), then a simple washing with water may remove the cell debris and regenerate the filter. While PBS is shown to be somewhat effective and the ethanol seems to be more effective, these two cleaning procedures show that it is possible to refresh the bactericidal activity of the polymer with an appropriate washing solution. For practical applications, multi-filter cells can be assembled and each filter cell can be washed and regenerated in sequence to maintain continuous effluent supply.

The filter is more suitable for drinking water and water re-use application, although its application for wastewater is possible as well. The wastewater generated from back-washing can include particulate matter (dead bacteria debris, and particulates initially present in the water), as well as the agent used for the washing/regeneration process. Depending on the agent used for the washing procedure, the generated wastewater could be either sent back to the main treatment train or sent into the sewage system. For the specific case of ethanol, there are no health based standards or guidelines for its presence in drinking water or reuse water. For wastewater treatment, addition of an external carbon source such as ethanol is commonly practiced to enhance denitrification. Therefore, ethanol use is an acceptable practice. The influent water at the head of the treatment plant can provide the necessary dilution of the filter wastewater without specific treatment. Moreover, compared to regular backwash wastewater produced in sand filter, the backwash wastewater of this specific filter does not contain different composition except a higher concentration of cell debris.

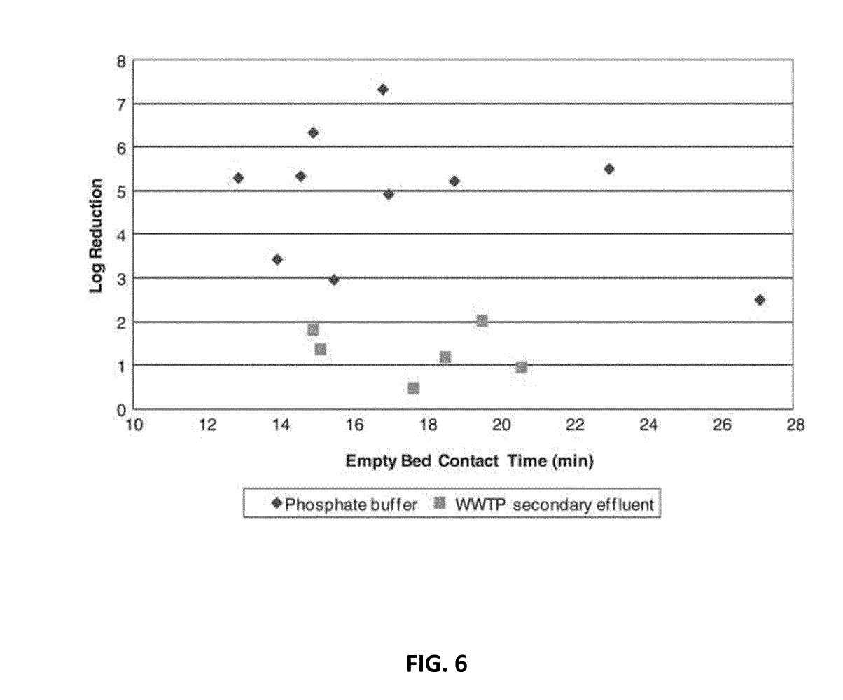

FIG. 6 shows the relationship found between the log reduction and the EBCT. Within 12 to 27 min of EBCT, the increasing contact time does not seem to enhance bacterial removal as expected. This implies that the inactivation process is likely limited by the unencumbered immobilized N,N-hexyl,methyl-PEI available to the microbes. The results indicated that the cleaning protocol and matrix of the sample play important roles; thus, providing more contact area (e.g. increased filter column depth, or greater available surface area) can be crucial in the application of this technology. The EBCT for effective inactivation is within the range of typical sand filter operation, suggesting the inactivation rate and kinetics are sufficient for real practical application. Previous inactivation kinetics studies with glass surface coated with this same antimicrobial polymer showed that, with initial E. Coli concentration up to 2×10⁷ cells, 6-log reduction can be achieved within half an hour when the polymer-coated slide is submerged in cell suspension (Milovic et al. 2005). This rate is comparable to the inactivation rate observed with our sand filter and the difference is due to the different hydraulic and contact conditions. In addition, real water effluents containing interfering organics and other compounds can compete with the bacteria for active sites on the surface, therefore reducing the disinfection capacity of the system.

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. The scope of the invention is as set forth in the appended claims and equivalents thereof, rather than being limited to the examples contained in the foregoing description.

What is claimed is:

1. A method of disinfecting water comprising:
providing sand, wherein said sand is covalently bonded to a polycationic polymer; and
disinfecting water by filtering said water through said sand.

2. The method of claim 1, wherein the sand is silica sand.

3. The method of claim 1, wherein the polycationic polymer is N-alkylated polyethylenimine (PEI).

4. The method of claim 3, wherein the polyethylenimine is branched.

5. The method of claim 3, wherein the N-alkylation is achieved by disubstitution of R₁ and R₂ at the N position, and wherein each R₁ and R₂ is independently selected from C₁-C₂₄.

6. The method of claim 3, wherein the N-alkylation is achieved by disubstitution of R₁ and R₂ at the N position, and wherein each R₁ and R₂ is independently selected from C₁-C₁₂.

7. The method of claim 3, wherein the N-alkylation is achieved by disubstitution of R₁ and R₂ at the N position, and wherein each R₁ and R₂ is independently selected from C₁-C₆.

8. The method of claim 3, wherein the N-alkylation is achieved by disubstitution of R₁ and R₂ at the N position, and wherein each R₁ and R₂ is independently selected from methyl, hexyl, and dodecyl.

9. The method of claim 3, wherein the N-alkylation is achieved by disubstitution of R₁ and R₂ at the N position, and wherein R₁ is selected from methyl and R₂ is selected from hexyl and dodecyl.

10. The method of claim 3, wherein the polycationic polymer is N,N-hexyl, methyl-PEI or N,N-dodecyl, methyl-PEI.

11. A water purification system comprising:
an elongate housing having a first end and a second end, said first end including surfaces defining a water inlet for admitting water into the housing, and said second end including surfaces defining a water outlet; and
biological purifiers disposed within the housing for killing biological organisms in the water,
wherein said biological purifiers include sand covalently bonded to a polycationic polymer.

12. The system of claim 11, further comprising solids purifiers disposed within the housing for removing solid contaminants from the water.

13. The system of claim 12, wherein said solids purifiers include a lower water permeable member located in said housing above said water inlet; said biological purifiers including sand covalently bonded to a polycationic polymer above said lower water permeable member.

14. The system of claim 11, wherein the polycationic polymer is N-alkylated polyethylenimine (PEI).

15. The system of claim 14, wherein the N-alkylation is achieved by disubstitution of R₁ and R₂ at the N position, and wherein each R₁ and R₂ is independently selected from methyl, hexyl, and dodecyl.

16. The system of claim 14, wherein the polycationic polymer is N,N-hexyl, methyl-PEI or N,N-dodecyl, methyl-PEI.

17. The system of claim 12, wherein said water permeable member include at least one of untreated sand and charcoal.

18. A composition comprising sand and a hydrophobic polycationic polymer covalently bonded to the sand.

19. The composition of claim 18, wherein the polycationic polymer is N-alkylated polyethylenimine (PEI).

20. The composition of claim 19, wherein the N-alkylation is achieved by disubstitution of R₁ and R₂ at the N position, and wherein each R₁ and R₂ is independently selected from methyl, hexyl, and dodecyl.

21. The composition of claim 19, wherein the polycationic polymer is N,N-hexyl, methyl-PEI or N,N-dodecyl, methyl-PEI.
